(19) United States
(12) Patent Application Publication
(10) Pub. No.: US 2018/0057255 A1
(43) Pub. Date: Mar. 1, 2018

(54) Receptacle Venting and Freshening Device

(71) Applicant: Michael Wright, East Bridgewater, MA (US)

(72) Inventor: Michael Wright, East Bridgewater, MA (US)

(21) Appl. No.: 15/248,246

(22) Filed: Aug. 26, 2016

(51) Int. Cl. B65F 1/06; B65F 1/00

(52) U.S. Cl. CPC B65F 1/068; B65F 2210/1815; B65F 2210/129; B65F 1/0026

(57) ABSTRACT

A receptacle venting and freshening device for facilitating removal of liners from trash cans includes a tube, which has a first surface that is complementary to a face of a receptacle. A top of the tube is positioned proximate to an upper end of the receptacle and a bottom of the tube rests on a lower end of the receptacle. A plurality of fasteners is coupled to the first surface and is configured to couple the tube to the receptacle. A hanger, coupled to an interior surface of the tube proximate to the top, is configured to retain an air freshener unit. A plurality of cutouts, positioned in the tube proximate to the bottom, is configured to allow air to flow over the air freshener unit to exit from the tube through the cutouts as a liner positioned in the receptacle is withdrawn from the receptacle to freshen the receptacle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to venting devices and more particularly pertains to a new venting device for facilitating removal of liners from trash cans.

### BRIEF SUMMARY OF THE INVENTION

An embodiment of the disclosure meets the needs presented above by generally comprising a tube, which has a first surface that is complementary to a face of a receptacle. A top of the tube is positioned proximate to an upper end of the receptacle and a bottom of the tube rests on a lower end of the receptacle. A plurality of fasteners is coupled to the first surface and is configured to couple the tube to the receptacle. A hanger, coupled to an interior surface of the tube proximate to the top, is configured to retain an air freshener unit. A plurality of cutouts, positioned in the tube proximate to the bottom, is configured to allow air to flow over the air freshener unit to exit from the tube through the cutouts as a liner positioned in the receptacle is withdrawn from the receptacle to freshen the receptacle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a receptacle venting and freshening device according to an embodiment of the disclosure.

FIG. 2 is an isometric perspective view of an embodiment of the disclosure.

FIG. 3 is an in-use view of an embodiment of the disclosure.

FIG. 4 is an in-use view of an embodiment of the disclosure.

FIG. 5 is a cross-sectional view of an embodiment of the disclosure.

FIG. 6 is a cross-sectional view of an embodiment of the disclosure.

### DETAILED DESCRIPTION OF THE INVENTION

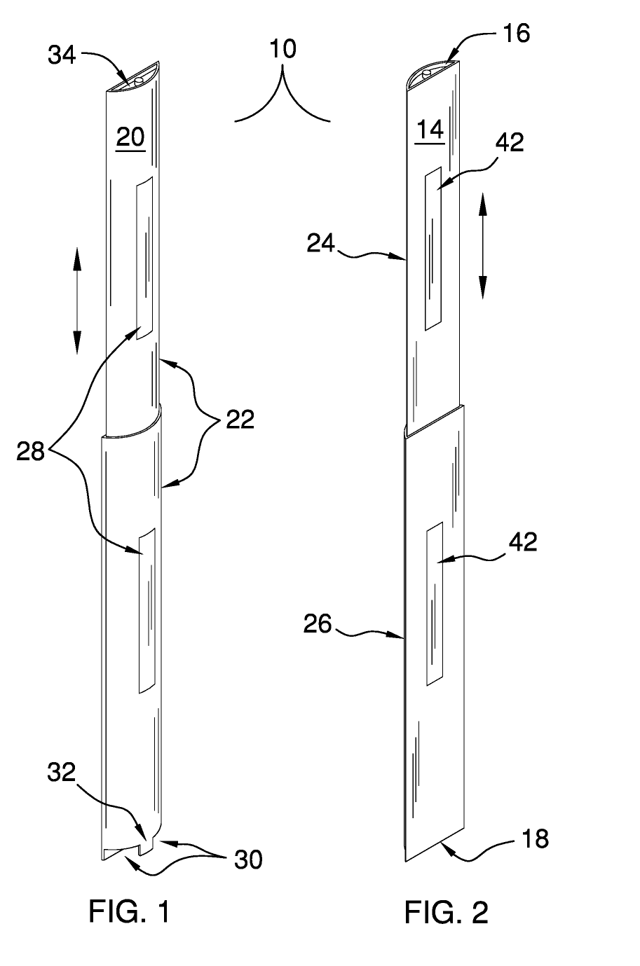

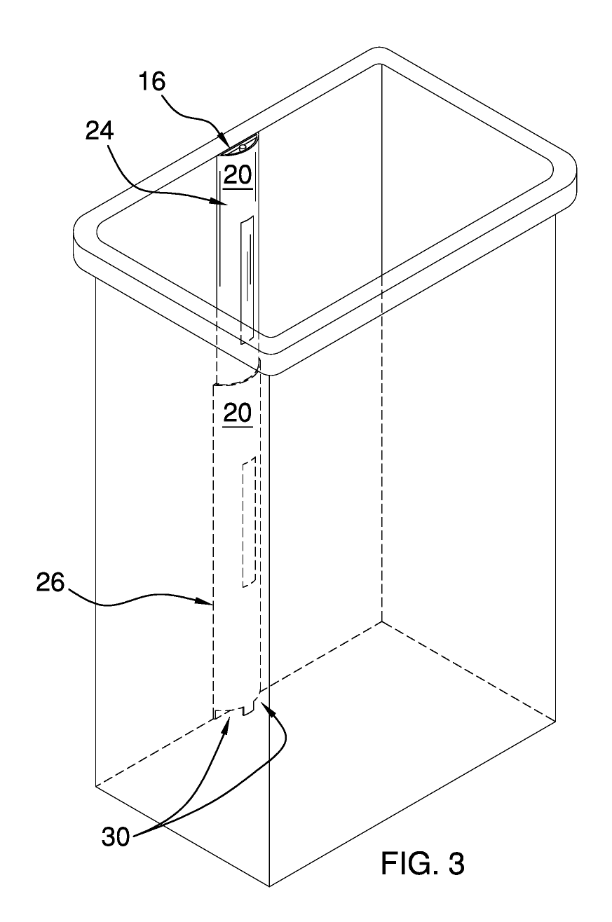

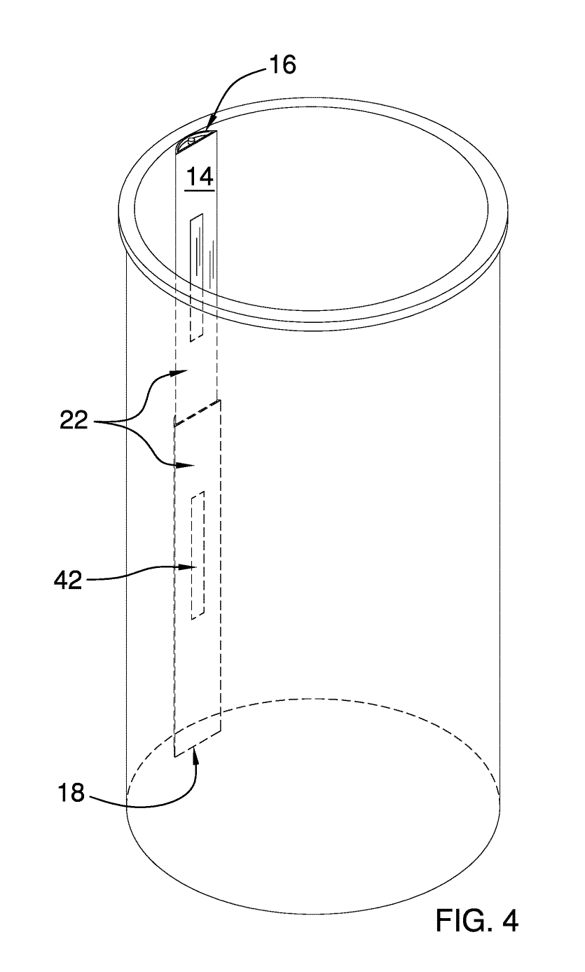

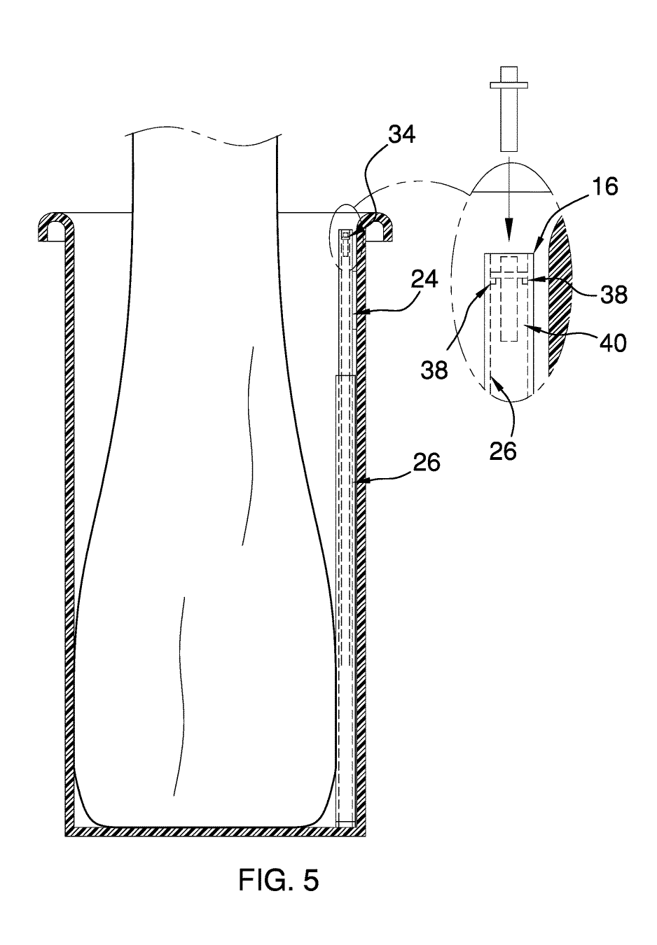

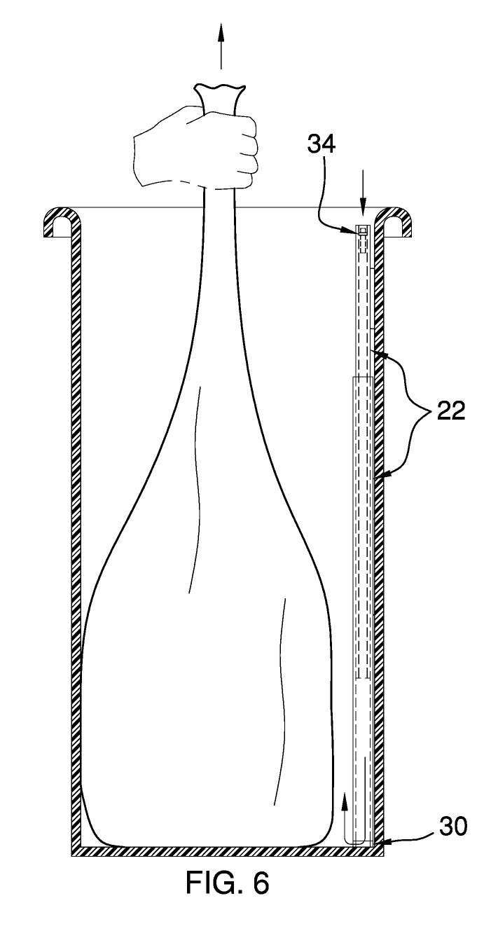

With reference now to the drawings, and in particular to FIGS. 1 through 6 thereof, a new venting device embodying the principles and concepts of an embodiment of the disclosure and generally designated by the reference numeral 10 will be described.

As best illustrated in FIGS. 1 through 6, the receptacle venting and freshening device 10 generally comprises a tube 12 that has a first surface 14. The first surface 14 is complementary to a face of a receptacle. The first surface 14 is configured to place adjacent to the face of the receptacle with a top 16 of the tube 12 positioned proximate to an upper end of the receptacle and a bottom 18 of the tube 12 resting on a lower end of the receptacle. In one embodiment, the first surface 14 is flat. In another embodiment, the tube 12 comprises a second surface 20 that is arcuate. The second surface 20 is configured to position adjacent to a curved face of the receptacle and the first surface 14 is configured to position adjacent to a planar face of the receptacle.

The tube 12 comprises a plurality of nested sections 22, such that the tube 12 is extendable to substantially match a distance between the upper end and the lower end of the receptacle. In one embodiment, the plurality of nested sections 22 comprises an upper segment 24 and a lower segment 26.

A plurality of fasteners 28 is coupled to the first surface 14. The fasteners 28 are configured to couple to the face of the receptacle. The fasteners 28 are positioned on the first surface 14 such that the fasteners 28 are configured to couple the tube 12 to the receptacle. In one embodiment, the fasteners 28 comprise double sided tape 42. In another embodiment, the plurality of fasteners 28 comprises fasteners 28 coupled singly to the first surface 14 and the second surface 20 on the upper segment 24 and to the first surface 14 and the second surface 20 on the lower segment 26. The fasteners 28 positioned on the first surface 14 are configured to selectively couple the tube 12 to the planar face of the receptacle and the fasteners 28 positioned on the second surface 20 are configured to selectively couple the tube 12 the curved face of the receptacle.

A plurality of cutouts 30 is positioned in the tube 12 proximate to the bottom 18 of the tube 12. The cutouts 30 are positioned in the tube 12 such that the cutouts 30 are configured to allow air to flow from the tube 12 through the cutouts 30 as a liner positioned in the receptacle is withdrawn from the receptacle. In one embodiment, the cutouts 30 are positioned in the second surface 20 of the tube 12. In another embodiment, the plurality of cutouts 30 comprises two cutouts 30 that define a spacer 32.

A hanger 34 is coupled to an interior surface 36 of the tube 12 proximate to the top 16 of the tube 12. The hanger 34 is configured to retain an air freshener unit. The hanger 34 is positioned in the tube 12 such that the hanger 34 is configured to retain the air freshener unit such that air drawn into the tube 12 as the liner positioned in the receptacle is withdrawn from the receptacle is drawn over and exposed to the air freshener unit to freshen the receptacle. In one embodiment, the hanger 34 comprises a lip 38 that is coupled to and extends around a perimeter 40 of the tube 12. The lip 38 is positioned on the tube 12 such that the lip 38 is configured to suspend the air freshener unit within the tube 12.

In use, the tube 12 is extendable to substantially match a distance between the upper end and the lower end of the receptacle. The second surface 20 is configured to selectively position adjacent to a curved face of the receptacle and the first surface 14 is configured to selectively position adjacent to a planar face of the receptacle, such that the tube 12 is couplable to receptacles having curved and planar surfaces. The fasteners 28 are positioned on the first surface 14 are configured to selectively couple the tube 12 to the planar face of the receptacle and the fasteners 28 positioned on the second surface 20 are configured to selectively couple the tube 12 to the curved face of the receptacle. The hanger 34 is positioned in the tube 12 and is configured to retain the air freshener unit. Air drawn into the tube 12 as the liner positioned in the receptacle is withdrawn from the receptacle is drawn over and exposed to the air freshener unit prior to exiting the tube 12 through the cutouts 30, thus freshening the receptacle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A receptacle venting device comprising:
a tube having a first surface, said first surface being complementary to a face of a receptacle, wherein said first surface is complementary to the face of the receptacle such that said first surface is configured for placement adjacent to the face of the receptacle with a top of said tube positioned proximate to an upper end of the receptacle and a bottom of said tube resting on a lower end of the receptacle;
a plurality of fasteners coupled to said first surface, said fasteners being configured to couple to the face of the receptacle, wherein said fasteners are positioned on said first surface such that said fasteners are configured to couple said tube to the receptacle;
a plurality of cutouts positioned in said tube proximate to said bottom of said tube, wherein said cutouts are positioned in said tube such that said cutouts are configured for air to flow from said tube through said cutouts as a liner positioned in the receptacle is withdrawn from the receptacle;
a hanger coupled to an interior surface of said tube proximate to said top of said tube, said hanger being configured to retain an air freshener unit; and
wherein said hanger is positioned in said tube such that said hanger is configured to retain the air freshener unit such that air drawn into said tube as the liner positioned in the receptacle is withdrawn from the receptacle is drawn over and exposed to the air freshener unit to freshen the receptacle.

2. The device of claim 1, further including said first surface being flat.

3. The device of claim 2, further including said tube comprising a second surface, said second surface being arcuate, wherein said second surface is configured for positioning adjacent to a curved face of the receptacle and said first surface is configured for positioning adjacent to a planar face of the receptacle.

4. The device of claim 3, further including said tube comprising a plurality of nested sections, such that said tube is extendable to substantially match a distance between the upper end and the lower end of the receptacle.

5. The device of claim 4, further including said plurality of nested sections comprising an upper segment and a lower segment.

6. The device of claim 1, further including said fasteners comprising double sided tape.

7. The device of claim 5, further including said plurality of fasteners comprising fasteners coupled singly to said first surface and said second surface on said upper segment and to said first surface and said second surface on said lower segment, wherein said fasteners positioned on said first surface are configured to selectively couple said tube to the planar face of the receptacle and said fasteners positioned on said second surface are configured to selectively couple said tube to the curved face of the receptacle.

8. The device of claim 3, further including said cutouts being positioned in said second surface of said tube.

9. The device of claim 8, further including said plurality of cutouts comprising two said cutouts defining a spacer.

10. The device of claim 1, further including said hanger comprising a lip coupled to and extending around a perimeter of said tube, wherein said lip is positioned on said tube such that said lip is configured to suspend the air freshener unit within said tube.

11. A receptacle venting and freshening device comprising:
a tube having a first surface, said first surface being complementary to a face of a receptacle, wherein said first surface is complementary to the face of the receptacle such that said first surface is configured for placement adjacent to the face of the receptacle with a top of said tube positioned proximate to an upper end of the receptacle and a bottom of said tube resting on a lower end of the receptacle, said first surface being flat, said tube comprising a second surface, said second surface being arcuate, wherein said second surface is configured for positioning adjacent to a curved face of the receptacle and said first surface is configured for positioning adjacent to a planar face of the receptacle, said tube comprising a plurality of nested sections, such that said tube is extendable to substantially match a distance between the upper end and the lower end of the receptacle, said plurality of nested sections comprising an upper segment and a lower segment;
a plurality of fasteners coupled to said first surface, said fasteners being configured to couple to the face of the receptacle, wherein said fasteners are positioned on said first surface such that said fasteners are configured to couple said tube to the receptacle, said fasteners comprising double sided tape, said plurality of fasteners comprising fasteners coupled singly to said first surface and said second surface on said upper segment and to said first surface and said second surface on said lower segment, wherein said fasteners positioned on said first surface are configured to selectively couple said tube to the planar face of the receptacle and said fasteners positioned on said second surface are configured to selectively couple said tube to the curved face of the receptacle;
a plurality of cutouts positioned in said tube proximate to said bottom of said tube, wherein said cutouts are positioned in said tube such that said cutouts are configured for air to flow from said tube through said cutouts as a liner positioned in the receptacle is withdrawn from the receptacle, said cutouts being positioned in said second surface of said tube, said plurality of cutouts comprising two said cutouts defining a spacer;
a hanger coupled to an interior surface of said tube proximate to said top of said tube, said hanger being configured to retain an air freshener unit, wherein said hanger is positioned in said tube such that said hanger is configured to retain the air freshener unit such that air drawn into said tube as the liner positioned in the receptacle is withdrawn from the receptacle is drawn over and exposed to the air freshener unit to freshen the receptacle, said hanger comprising a lip coupled to and extending around a perimeter of said tube, wherein said lip is positioned on said tube such that said lip is configured to suspend the air freshener unit within said tube; and
wherein said tube is extendable to substantially match a distance between the upper end and the lower end of the receptacle, such that said second surface is configured for positioning adjacent to a curved face of the receptacle and said first surface is configured for positioning adjacent to a planar face of the receptacle, wherein said fasteners positioned on said first surface are configured to selectively couple said tube the planar face of the receptacle and said fasteners positioned on said second surface are configured to selectively couple said tube the curved face of the receptacle, wherein said hanger is positioned in said tube such that said hanger is configured to retain the air freshener unit such that air drawn into said tube as the liner positioned in the receptacle is withdrawn from the receptacle is drawn over and exposed to the air freshener unit prior to exiting said tube through said cutouts to freshen the receptacle.
